(19) United States
(12) Patent Application Publication
(10) Pub. No.: US 2026/0135921 A1
(43) Pub. Date: May 14, 2026

(54) TASK PROCESSING

(71) Applicant: Beijing Zitiao Network Technology Co., Ltd., Beijing (CN)

(72) Inventors: Xiaochuan MI, Beijing (CN); Qian LIN, Beijing (CN); Di AI, Beijing (CN); Qiang LIU, Beijing (CN); Qingxu LI, Beijing (CN)

(21) Appl. No.: 19/348,690

(22) Filed: Oct. 2, 2025

(30) Foreign Application Priority Data
Nov. 8, 2024 (CN) 202411596932.7

(51) Int. Cl. H04L 67/50

(52) U.S. Cl. CPC H04L 67/50

(57) ABSTRACT

Method for task processing, a device, a storage medium are provided. A disclosed method includes: receiving, from a server device, a task execution instruction for execution corresponding to a task request in response to sending the task request to the server device; receiving prediction information for the task request from the server device, the prediction information indicating at least one predicted execution result of the task execution instruction and a predicted response respectively corresponding to the at least one predicted execution result; and providing, in response to a completion of executing the task execution instruction, a response to the task request based on a match between a target execution result of the task execution instruction and the at least one predicted execution result.

### CROSS-REFERENCE

This application claims the benefit of Chinese Patent Application No. 202411596932.7 filed on Nov. 8, 2024, entitled “METHOD, APPARATUS, DEVICE, STORAGE MEDIUM AND PROGRAM PRODUCT FOR TASK PROCESSING”, which is hereby incorporated by reference in its entirety.

### FIELD

Example embodiments of the present disclosure generally relate to the field of computers, and in particular, to task processing.

### BACKGROUND

With the development of information technologies, various terminal devices may provide various services to people in terms of work and life. For example, an application providing a service may be deployed in the terminal device. The terminal device or the application may provide a task processing function to a user, to assist the user in using the terminal device or the application.

### SUMMARY

In a first aspect of the present disclosure, a method for task processing is provided. The method is implemented at a client device, and includes: receiving, from a server device, a task execution instruction for execution corresponding to a task request in response to sending the task request to the server device; receiving prediction information for the task request from the server device, the prediction information indicating at least one predicted execution result of the task execution instruction and a predicted response respectively corresponding to the at least one predicted execution result; and providing, in response to a completion of executing the task execution instruction, a response to the task request based on a match between a target execution result of the task execution instruction and the at least one predicted execution result.

In a second aspect of the present disclosure, a method for task processing is provided. The method is implemented at a server device, and includes: determining, in response to receiving a task request from a client device, a task execution instruction corresponding to the task request based on the task request; determining prediction information for the task request based on the task execution instruction; and sending the prediction information to the client device.

In a third aspect of the present disclosure, an apparatus for task processing is provided. The apparatus is implemented at a client device, and includes: a task request sending module configured to receive, from a server device, a task execution instruction for execution corresponding to a task request in response to sending the task request to the server device; a prediction information receiving module configured to receive prediction information for the task request from the server device, the prediction information indicating at least one predicted execution result of the task execution instruction and a predicted response respectively corresponding to the at least one predicted execution result; and a response providing module configured to provide, in response to a completion of executing the task execution instruction, a response to the task request based on a match between a target execution result of the task execution instruction and the at least one predicted execution result.

In a fourth aspect of the present disclosure, an apparatus for task processing is provided. The apparatus is implemented at a server device, and includes: a task request receiving module, configured to determine, in response to receiving a task request from a client device, a task execution instruction corresponding to the task request based on the task request; a prediction information determining module, configured to determine prediction information for the task request based on the task execution instruction; and a prediction information sending module, configured to send the prediction information to the client device.

In a fifth aspect of the present disclosure, an electronic device is provided. The electronic device includes at least one processor; and at least one memory coupled to the at least one processor and storing instructions executable by the at least one processor. The instructions, when executed by the at least one processor, cause the electronic device to perform the method of the first aspect and/or the second aspect.

In a sixth aspect of the present disclosure, a computer-readable storage medium is provided. The medium stores a computer program. The computer program, when executed by a processor, causes the method of the first aspect and/or the second aspect to be performed.

In a seventh aspect of the present disclosure, a computer program product is provided. The product includes a computer program. The computer program, when executed by a processor, causes the method of the first aspect and/or the second aspect of the present disclosure to be performed.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, in which:

FIG. 1 illustrates a schematic diagram of an example environment in which embodiments of the present disclosure can be implemented;

FIG. 2 illustrates a flowchart of a signaling flow for task processing according to some embodiments of the present disclosure;

FIG. 3 illustrates a flowchart of a method for task processing according to some embodiments of the present disclosure;

FIG. 4 illustrates a flowchart of a task processing method according to some other embodiments of the present disclosure;

FIG. 5 illustrates an example block diagram of an apparatus for task processing according to some embodiments of the present disclosure;

FIG. 6 illustrates an example block diagram of an apparatus for task processing according to some further embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

As used herein, unless explicitly stated, “responding to A” performs one step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network, and the output of the output layer serves as the final output of the neural network. Each layer of the neural network includes one or more nodes (also referred to as processing nodes or neurons), each node processing input from the previous layer.

Generally, machine learning may generally include three phases, a training phase, a testing phase, and an application phase (also referred to as an inference phase). At the training stage, a given model may be trained using a large amount of training data, constantly updating the parameter values, until the model is able to obtain consistent inferences from the training data that satisfy the expected objectives. By training, the model may be considered to be able to learn from the training data an association from input to output (also referred to as mapping of input to output). The parameter values of the trained model are determined. In the testing phase, the test input is applied to the trained model to test whether the model can provide the correct output, thereby determining the performance of the model. The testing phase may sometimes be fused in a training phase. In the application or inference stage, the trained model may be used to process the actual model input based on the parameter value obtained by training, to determine a corresponding model output.

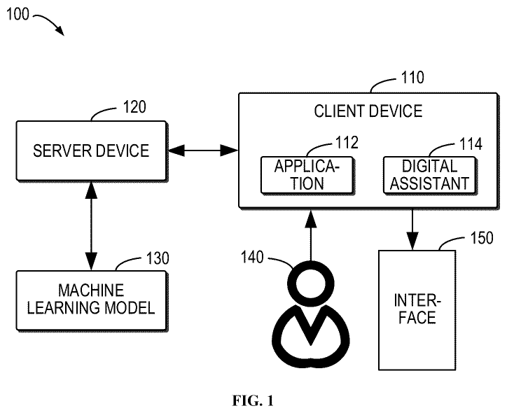

FIG. 1 illustrates a schematic diagram of an example environment 100 in which embodiments of the present disclosure can be implemented. In the example environment 100, an application 112 and a digital assistant 114 are installed in the client device 110. The user 140 may interact with the application 112 via the client device 110 and/or an attachment device of the client device 110. In some implementations, the application 112 may be authorized to capture speech via an audio capture device (e.g., a microphone) of the client device 110, capture images via an image capture device (e.g., a camera) of the client device 110, and/or the like.

In some embodiments, the application 112 and the digital assistant 114 may be downloaded, and installed on the client device 110. In some embodiments, the application 112 and the digital assistant 114 may also be accessed in other manners, such as through a web page.

In some example embodiments of the present disclosure, the application 112 may be any suitable application having a task processing function, which may include, but is not limited to, one or more of the following: a chat application component (also referred to as an instant messaging application component), a browser application component, a planning application component, a document application component, an audio and video conference application component, a mail application component, a task application component, a calendar application component, an objective and key result (OKR) application component, and the like. It may be understood that although a single application service component is shown in FIG. 1, in practice, multiple application service components may be installed on the client device 110. In some embodiments, the application 112 may include a multifunctional collaboration platform, for example, an office collaboration platform (also referred to as an office suite), which can provide integration of multiple types of business components, so that people can conveniently perform activities such as office and communication. In the multifunctional collaboration platform, people can start different service components according to needs to complete corresponding information processing, sharing, communication and the like.

In some embodiments, the digital assistant 114 may be provided by a separate application business component, or may be integrated in some application 112 capable of providing a content entity. An application business component for providing a client interface of a digital assistant may correspond to a single function application business component or a multifunction collaboration platform, such as an office suite or other collaboration platform capable of integrating multiple components. It is to be understood that although a single digital assistant is shown in FIG. 1, a plurality of digital assistants may actually be provided.

The digital assistant 114 is a user's intelligent assistant, and has an intelligent dialogue and information processing capability. In some embodiments of the present disclosure, the digital assistant 114 may be configured to interact with the user 140 to assist the user 140 in using the terminal device or the application. In some embodiments, multiple interaction modes between the user 140 and the digital assistant 114 may be provided, and flexible switching between the multiple interaction modes may be supported. In the event that a certain interaction mode is triggered, a corresponding interaction area may be presented to facilitate interaction of the user 140 with the digital assistant 114. The interaction manners between the user 140 and the digital assistant 114 may vary under different interaction modes, which may flexibly adapt to interaction requirements in different application scenarios.

In the environment 100, in response to the launch of the application 112, the client device 110 may present an interface 150 for the application 112 and/or the digital assistant 114. The interface 150 may include, for example, an interactive interface of the application 112 and the digital assistant 114. In some embodiments, the interface 150 may present an interaction window between the user 140 and the digital assistant 114. In the interaction window, the user 140 may interact with the digital assistant 114 by inputting a natural language, an image, an audio file, a video file, a web page file, etc., to instruct the digital assistant to assist in completing various tasks.

The interaction window between the digital assistant 114 and the user 140 may include a session window, such as a session window in an instant messaging application or an instant messaging module of a particular application. In the session window, the interaction between the digital assistant 114 and the user 140 may be presented in the form of a session message. Alternatively, or additionally, the interaction window of the digital assistant 114 and the user 140 may further include other types of windows, such as a window of a floating-window mode, where the user 140 may trigger the digital assistant 114 to perform the corresponding operation by inputting an instruction, selecting a shortcut instruction, or the like.

In some embodiments, the digital assistant 114 may support an interaction mode of a session window, also referred to as a session mode. In this interaction mode, a session window of the user 140 and the digital assistant 114 may be presented, and the user 140 may interact with the digital assistant 114 through the session message in the session window. In the session mode, the digital assistant 114 may perform a task according to the session message in the session window. In the interaction window, the user 140 may enter an interaction message, and the digital assistant 114 may provide a reply message in response to the user input. By selecting the digital assistant 114, a session window with the digital assistant 114 may be opened. The session window may include interface elements for information interaction, such as input boxes, message lists, message bubbles, and the like.

In some embodiments, a communication connection is established between the client device 110 and the server device 120. The communication connection may be established in a wired manner or a wireless manner. The communication connection may include, but is not limited to, a Bluetooth connection, a mobile network connection, a universal serial bus (USB) connection, a wireless fidelity (Wi-Fi) connection, and the like, and the embodiments of the present disclosure are not limited in this aspect. In an embodiment of the present disclosure, the client device 110 and the server device 120 may implement signaling interaction through a communication connection between the client device 110 and the server device 120, so as to supply services of the application 112 and/or the digital assistant 114.

As shown in FIG. 1, the server device 120 may invoke the machine learning model 130 to support functionality of the application 112 and/or the digital assistant 114 based on the output of the machine learning model 130. The machine learning model 130 may be based on any suitable model structure including, but not limited to, a Transformer model, a convolutional neural network (CNN), a recurrent neural network (RNN), a deep neural network (DNN), or the like. In some embodiments, the machine learning model 130 may be based on a language model (LM). The language model can have question-answering capability by learning from a large corpus of corpora. The machine learning model 130 may also be based on other suitable models.

The machine learning model 130 may be deployed on the server device 120, or may be deployed on other devices. The machine learning model 130 may include one or more machine learning models. It should be noted that, if the machine learning model 130 includes a plurality of machine learning models, the plurality of machine learning models may have different uses and functions, which is not limited in the present disclosure.

The client device 110 may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. In some embodiments, the client device 110 can also support any type of interface for a user (such as a “wearable” circuit, etc.).

The server device 120 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, or the like.

It should be understood that the structures and functions of the various elements in the environment 100 are described for illustrative purposes only and do not imply any limitation to the scope of the present disclosure.

As described above, the terminal device or the application may provide a task processing function to a user, to assist the user in using the terminal device or the application. The terminal device may receive a task request from the user, perform a task corresponding to the task request, and provide a corresponding response to the user based on an execution result of the task. In a human-machine interaction process, a user may be supported to input a task request through speech or text at a client device. The server device and/or the client device may determine the task to be performed by analyzing the task request. Depending on the specific content of the task, the task may be performed at the server device or at the client device. If the task is to be executed at the client, the server device may send a task execution instruction to the client device. The server device may determine a response to the task request based on the execution result of the task, and the response may then be provided to the user by the client device.

In the conventional processing flow, the client device may send the task request input by the user to the server device. The server device may send a task execution instruction to the client device based on the received task request. The client device may execute the task request based on the received task execution instruction, and send the execution result to the server device. In response to the received execution result, the server device may determine a response to the task request based on the execution result, and deliver the response to the client device. The client device may provide the response to the user in response to receiving the response.

It may be found that the link of the conventional task processing mode is long. After executing the task execution instruction, the client device needs to provide the execution result to the server device, and then provides a response to the execution result sent by the server device to the user. Therefore, after executing the task execution instruction, the client device still needs to wait for a period of time (e.g., tens of milliseconds or hundreds of milliseconds) to obtain the response, which affects the efficiency of the user in obtaining the response. In addition, the communication between the client device and the server device usually relies on the network. In the case of poor network conditions, even if the client device has completed executing the task execution instruction, it may still fail to obtain the response from the server device. Thus, the client device may fail to provide the response to the user, leaving the user unaware of the execution status of the task request, and impacting interaction experience of the user.

In view of this, embodiments of the present disclosure provide a solution for task processing. According to the solution of the embodiments of the present disclosure, at the client device side, in response to sending the task request to the server device, a task execution instruction for execution corresponding to the task request is received from the server device. The prediction information for the task request is received from the server device, and the prediction information indicates at least one predicted execution result of the task execution instruction and a predicted response respectively corresponding to the at least one predicted execution result. In response to a completion of executing the task execution instruction, a response to the task request is provided based on a match between a target execution result of the task execution instruction and the at least one predicted execution result.

According to the solution of embodiments of the present disclosure, at the server device side, in response to receiving the task request from the client device, the task execution instruction corresponding to the task request is determined based on the task request. The prediction information for the task request is determined based on the task execution instruction. The prediction information is sent to the client device.

In this way, the server device may determine the prediction information based on the task execution instruction, and send the prediction information to the client device. The prediction information indicates at least one predicted execution result of the task execution instruction and a predicted response respectively corresponding to the at least one predicted execution result. The client device may determine a matching result between the target execution result of the task execution instruction and the at least one predicted execution result, and determine, in response to the at least one predicted execution result including a target predicted execution result that matches the target execution result, a predicted response corresponding to the target predicted execution result as the response to the task request. In this case, the client device does not need to resend the target execution result to the server device. The stability and efficiency of the client device in providing the response may be improved.

Some example embodiments of the present disclosure will be described below with continued reference to the accompanying drawings.

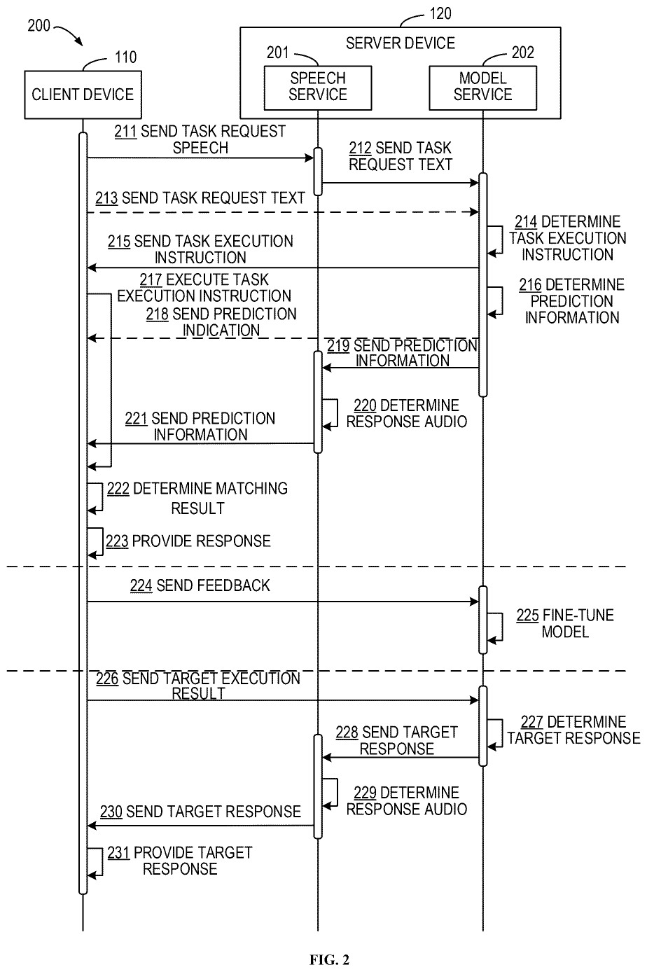

FIG. 2 illustrates a flowchart of a signaling flow 200 for task processing according to some embodiments of the present disclosure. For ease of discussion, the signaling flow 200 will be described with reference to FIG. 1. As illustrated in FIG. 2, the signaling flow 200 involves the client device 110 and the server device 120, where the server device 120 includes a speech service 201 and a model service 202.

The speech service 201 may provide speech processing services with a trained speech processing model. For example, the speech processing services may include text to speech (TTS) services (also referred to as text-to-speech services) and automatic speech recognition (ASR) services (also referred to as speech-to-text services). Accordingly, the speech processing model may include a machine learning model for performing TTS (simply referred to as the TTS model) and a machine learning model for performing ASR (simply referred to as the ASR model). The input to the ASR model is speech and the output is text. The input of the TTS model is text, and the output is the corresponding speech.

The model service 202 may provide task processing services, response services, etc., by using a trained machine learning model. It will be appreciated that, depending on the specific service, the model service 202 may utilize different models to provide corresponding services. As an example, the model service 202 may provide a question and answer service by using a question-answering model, where an input of the question and answer model is a question text, and an output is the corresponding response text. It may be understood that the machine learning model used by the speech service 201 and the model service 202 may be based on any suitable model structure, including but not limited to a Transformer model, a convolutional neural network (CNN), a recurrent neural network (RNN), a deep neural network (DNN), or the like. In some embodiments, the machine learning model may also be based on a language model (LM).

In some embodiments, the client device 110 may receive a task request from a user (e.g., the user 130) in any suitable manner. For example, the client device 110 may receive a task request input by the user via a microphone, an input box, or the like. In some embodiments, the task request may include a user question directed to the digital assistant. The client device 110 receives the user question during the interaction between the user and the digital assistant. For example, the client device 110 may receive the user question through an interaction interface of the application 112 and/or the digital assistant 114, and in response to determining that the user question indicates a task, determine the user question as a task request. As an example, the task request may be presented in the interaction interface in the form of a session message from the user. It may be understood that during the interaction between the user and the digital assistant, the client device 110 may receive a plurality of task requests, which may correspond to a plurality of tasks.

The client device 110 may send the received task request to the server device 120. It may be understood that the task request may be of any suitable type, such as a text type, a speech type, etc. In some embodiments, if the task request is a speech-type request (which may be referred to as a task request speech), the client device 110 may send (211) the task request speech to the speech service 201 in the server device 120. The speech service 201 may determine, by utilizing an ASR model, a task request text corresponding to the task request speech, and send (212) the task request text to the model service 202. It may be understood that, if the task request is directly a text-type request (which may be referred to as a task request text), the client device 110 may directly send (213) the task request text to the model service 202 in the server device 120.

The server device 120 may determine (214), in response to receiving the task request from the client device, a task execution instruction corresponding to the task request based on the task request. It may be understood that the server device 120 may determine the task execution instruction in any suitable manner. In some embodiments, if the model service 202 receives the task request, the model service 202 may determine the task execution instruction corresponding to the task request by utilizing the trained machine learning model.

The server device 120 may send (215) the determined task execution instruction to the client device 110. The client device 110 may receive the task execution instruction and determine a task execution result for the task request by executing (217) the task execution instruction. For example, if the task request is “enabling Bluetooth”, the server device 120 may send, to the client device 110, an instruction indicating to turn on Bluetooth based on the task request. The client device 110 may turn on its Bluetooth by executing the instruction.

In some embodiments, the server device 120 may further determine (216) prediction information for the task request based on the task execution instruction. Regarding the timing for determining the prediction information, to prevent the scenario where the client device 110 has completed the execution of the task execution instruction and sent the execution result for the task execution instruction to the server device 120 when the server device 120 determines the prediction information, the server device 120 may determine the prediction information without having received the execution result of the task execution instruction. In this case, if the server device 120 has received the execution result, it may no longer continue to determine the prediction information, and directly determine a response to the execution result.

In some embodiments, the server device 120 may further determine a type of the task execution instruction or the task request, and in response to the type being a predetermined type, determine the prediction information based on the task execution instruction. For example, the server device 120 may obtain a set of predetermined types, which may be set by the user or determined by the server device 120 or the client device 110. For example, the server device 120 may determine the prediction information in response to the task execution instruction being of the predetermined type, and not determine the prediction information in response to the task execution instruction not being of the predetermined type.

Regarding the manner of determining the prediction information, the server device 120 may determine, for example, at least one predicted execution result corresponding to the task execution instruction based at least on the task execution instruction. The server device 120 may further determine, by using the trained language model, a predicted response respectively corresponding to the at least one predicted execution result. The server device 120 may then determine the prediction information based at least on the at least one predicted execution result and the predicted response respectively corresponding to the at least one predicted execution result. For example, the server device 120 may determine at least one prediction result identification (for example, may be referred to as a prediction code) corresponding to the at least one predicted execution result. The prediction result identification may be any suitable identification such as a code, a number, a text, an image, or the like.

The server device 120 may determine the prediction result identification in any suitable manner. For example, the server device 120 may obtain a correspondence table between the result identification and the execution result, and determine the prediction result identification corresponding to each predicted execution result by searching the table. The server device 120 may then determine the prediction information based on the at least one predicted execution result, the at least one prediction result identification, and the predicted response respectively corresponding to the at least one predicted execution result.

The server device 120 may determine the at least one predicted execution result in any suitable manner. In some embodiments, if the task request corresponds to a target user (that is, the task request is from the target user), the server device 120 may determine the at least one predicted execution result based on the task execution instruction and the historical interaction information associated with the target user., For example, the historical interaction information may indicate user attribute information of the target user, historical task requests of the target user, historical execution results and historical responses to the historical task requests, and the like.

In some embodiments, the model service 202 in the server device 120 may determine the at least one predicted execution result with a trained prediction model. For example, the model service 202 may determine a prompt input for the prediction model based at least on the task execution instruction and historical interaction information associated with the target user. For example, the model service 202 may obtain a prompt template, and determine the prompt input by filling the task execution instruction and the historical interaction information into the prompt template. The model service 202 may determine the at least one predicted execution result based on the task execution instruction and the historical interaction information by providing the prompt input to the prediction model.

The model service 202 may determine the predicted response for each predicted execution result with a trained language model. For example, the model service 202 may construct a prompt input for the language model based on the predicted execution result. The prompt input may guide the language model to determine the response to the predicted execution result, i.e., the predicted response to the predicted execution result. The model service 202 may then determine the prediction information based on the at least one predicted execution result and the predicted response respectively corresponding to the at least one predicted execution result.

In some embodiments, the predicted response may default to a response of the text type (which may be referred to as a response text). If the client device 110 may present the response text to the target user, the model service 202 may directly send the prediction information to the client device 110. In some embodiments, if the client device 110 may present a response of the audio or speech type (which may be referred to as response audio) to the target user, the server device 120 may convert the predicted response of the text type to the audio type. As an example, the model service 202 may send (219) prediction information to the speech service 201, to indicate the speech service 201 to convert the predicted response to the audio type.

After receiving the prediction information, the speech service 201 may determine (220) the corresponding response audio based on the response text in the prediction information. For example, the speech service 201 may convert the response text in the prediction information to the response audio with a TTS model. The server device 120 may then send (221) the prediction information including the response audio to the client device 110.

In some embodiments, the server device 120 may further obtain a predetermined condition, which may indicate a predetermined number for the predicted execution result. If the at least one predicted execution result includes a plurality of predicted execution results, and the number of predicted execution results included in the plurality of predicted execution results exceeds the predetermined number, the server device 120 may determine, from the plurality of predicted execution results, a predetermined number of predicted execution results that best matches the target user based on the historical interaction information associated with the target user. For example, if the task execution instruction indicates enabling Bluetooth on the client device 110, the predicted execution result for this task execution instruction may include two predicted execution results, including successful Bluetooth enabling and failed Bluetooth enabling. If the historical interaction information suggests that the Bluetooth is typically enabled successfully and the predetermined number is 1, the server device 120 may determine, from the two predicted execution results, “successful Bluetooth enabling” as the single predicted execution results that best matches the target user. The server device 120 may then only determine a set of predicted responses corresponding to this set of predicted execution results, and determine the predicted information based on this set of predicted execution results and this set of predicted responses.

In some embodiments, before sending the prediction information, the server device 120 may further send (218), to the client device 110, a prediction indication for provision of the prediction information in response to determining the prediction information. After receiving the prediction indication, the client device 110 may know, based on the prediction indication, that the server device 120 is about to send the prediction information to the client device 110. The server device 120 may send the prediction information to the client device 110 after sending the prediction indication. It may be understood that although step 218 is before step 219 in FIG. 2, in practice, step 218 may occur after step 220 and before step 221, or step 218 may occur after step 216 and before step 222.

The client device 110 may receive the prediction information for the task request from the server device 120. The prediction information may indicate at least one predicted execution result of the task execution instruction and the predicted response respectively corresponding to the at least one predicted execution result. In some embodiments, the client device 110 may receive the prediction information from the server device 120 before the completion of executing the task execution instruction. That is, if the execution of the task execution instruction has been completed, the client device 110 may select not to receive the prediction information even if the server device 120 sends the prediction information to it at that time.

Alternatively, or additionally, in some embodiments, the client device 110 may receive the prediction information from the server device 120 within a preset time period after the completion of executing the task execution instruction. As an example, the preset time period is 1s, in the case that the execution of the task execution instruction has been completed, if the server device 120 sends the prediction information to the client device 110 within 1s, the client device 110 may receive the prediction information. If the server device 120 sends the prediction information to the client device 110 after 1s (e.g., the 2s after completion of the execution), the client device 110 may reject receiving the prediction information.

After the completion of executing the task execution instruction, the client device 110 may determine (222) a matching result between a target execution result of the task execution instruction and the at least one predicted execution result. It will be appreciated that if the client device 110 receives the prediction information before the completion of executing the task execution instruction, the client device 110 may cache the prediction information for subsequent determination of the response based on the prediction information. For example, the client device 110 may compare the target execution result with the at least one predicted execution result in the prediction information, and in response to determining a certain predicted execution result that matches the target execution result from the at least one predicted execution result, determine this predicted execution result as the target predicted execution result that matches the target execution result.

In some embodiments, if the prediction information further indicates respective prediction result identifications corresponding to each predicted execution result, the client device 110 may also compare a result identification (also referred to as a result code, which may include any suitable identification such as a code, a number, a text, an image, etc.) corresponding to the target execution result with the prediction result identification included in the prediction information, and search, from the prediction result identification included in the prediction information, a prediction result identification that is the same as the result identification. The client device 110 may determine the prediction result identification as the target prediction result identification that matches the result identification. The client device 110 may then determine the predicted execution result corresponding to the target prediction result identification as the target predicted execution result that matches the target execution result.

In response to determining the target predicted execution result from the at least one predicted execution result (that is, the at least one predicted execution result includes a predicted execution result that matches the target execution result, or the at least one prediction result identification corresponding to the at least one predicted execution result includes a prediction result identification that is the same as the result identification corresponding to the target execution result), the client device 110 may then determine the predicted response corresponding to the target predicted execution result as the response to the task request.

The client device 110 may provide (223) the response to the target user. For example, if the prediction information includes the response text, the client device 110 may present the response text via the screen. If the prediction information includes response audio, the client device 110 may play the response audio via a speaker.

In some embodiments, the client device 110 may also receive feedback to the provided response (i.e., the predicted response corresponding to the target predicted execution result), and send (224) the feedback to the server device 120. The feedback may indicate, for example, a satisfaction degree, a preference degree, and the like of the target user for the response or prediction information. The server device 120 may adjust, in response to receiving the feedback to the prediction information, the determination of the prediction information of a subsequent task request based on the feedback. For example, if the server device 120 determines at least one predicted execution result with a prediction model, and determines a predicted response for each predicted execution result with a language model, the server device 120 may fine-tune (225) the prediction model and/or the language model based on the feedback. Therefore, the accuracy of the determination of the subsequent prediction information may be improved, making the user more satisfied with the prediction information determined subsequently.

In some embodiments, the client device 110 may further send (226) the target execution result to the server device 120 in response to determining that the target execution result matches none of the at least one predicted execution result (that is, the at least one predicted execution result does not include a predicted execution result that matches the target execution result, or the at least one prediction result identification does not include a prediction result identification that is the same as the result identification), or in response to not receiving the prediction information (including both the case where the server device 120 does not send the prediction information and the case where the client device 110 does not receive the prediction information, it may be understood that the client device 110 does not receive the prediction information after the completion of executing the task execution instruction or after the preset time period after the completion of executing the task execution instruction).

The server device 120 may determine (227) a target response for the target execution result based on the execution result in response to receiving the execution result from the client device 110. The server device 120 may determine the response in any suitable manner. For example, the model service 202 in the server device 120 may determine the target response based on the target execution result with the trained machine learning model. The server device 120 may send the target response to the client device 110 in response to determining the target response.

Similarly, after determining the target response with the language model, the model service 202 may directly send the target response of the text type to the client device 110, or may send the target response to the speech service 201 to indicate the speech service 201 to convert the target response to the audio type. The speech service 201 may determine (229) the corresponding response audio based on the target response of the text type in response to receiving the target response. For example, the speech service 201 may convert the target response to the response audio with a TTS model. The server device 120 may then send (230) the response audio corresponding to the target response to the client device 110. The client device 110 may provide (231) the target response to the target user.

In summary, according to embodiments of the present disclosure, the server device may determine the prediction information based on the task execution instruction, and send the prediction information to the client device. The prediction information may indicate at least one predicted execution result of the task execution instruction and the predicted response respectively corresponding to the at least one predicted execution result. The client device may determine a matching result between the target execution result of the task execution instruction and the at least one predicted execution result, and determine, in response to the at least one predicted execution result including a target predicted execution result that matches the target execution result, a predicted response corresponding to the target predicted execution result as the response to the task request. In this case, the client device does not need to resend the target execution result to the server device. The stability and efficiency of the client device in providing the response may be improved.

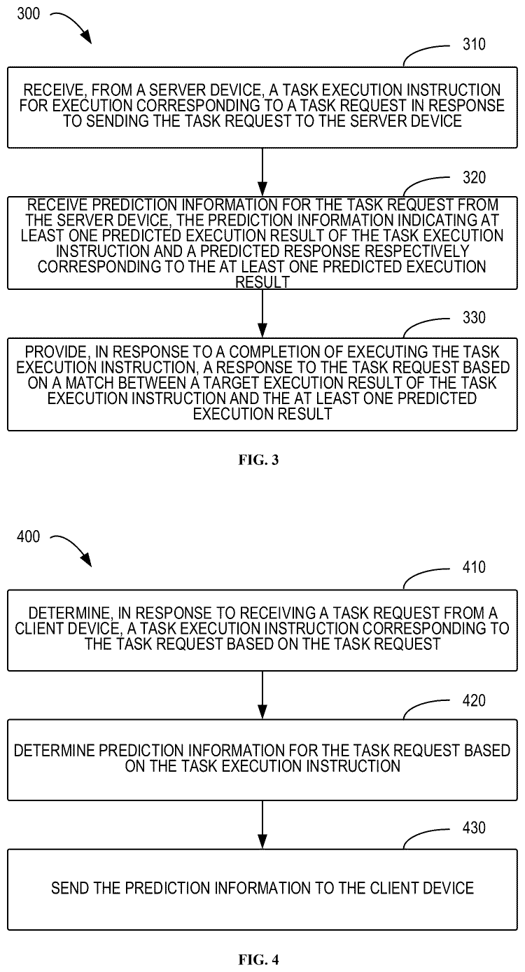

FIG. 3 illustrates a flowchart of a task processing method 300 according to some embodiments of the present disclosure. The method 300 may be implemented at the client device 110. The method 300 will be described below with reference to FIG. 1.

At block 310, the client device 110 receives, from a server device 120, a task execution instruction for execution corresponding to a task request in response to sending the task request to the server device 120.

At block 320, the client device 110 receives prediction information for the task request from the server device 120, the prediction information indicating at least one predicted execution result of the task execution instruction and a predicted response respectively corresponding to the at least one predicted execution result.

At block 330, the client device 110 provides, in response to a completion of executing the task execution instruction, a response to the task request based on a match between a target execution result of the task execution instruction and the at least one predicted execution result.

In some embodiments, receiving the prediction information for the task request from the server device 120 includes: receiving the prediction information from the server device before the completion of executing the task execution instruction; or receiving the prediction information from the server device within a preset time period after the completion of executing the task execution instruction.

In some embodiments, receiving the prediction information for the task request from the server device 120 includes: receiving a prediction indication for provision of the prediction information from the server device 120; and receiving the prediction information from the server device 120.

In some embodiments, providing the response to the task request based on the match between the target execution result of the task execution instruction and the at least one predicted execution result includes: comparing the target execution result with the at least one predicted execution result; and providing a target predicted response corresponding to a target predicted execution result in response to determining the target predicted execution result that matches the target execution result from the at least one predicted execution result.

In some embodiments, the prediction information further indicates at least one prediction result identification corresponding to the at least one predicted execution result, and comparing the target execution result with the at least one predicted execution result includes: comparing a result identification corresponding to the target execution result with the at least one prediction result identification; and determining that the target predicted execution result corresponding to a target prediction result identification matches the target execution result in response to determining the target prediction result identification that matches the result identification from the at least one prediction result identification.

In some embodiments, the method 300 further includes: sending the target execution result to the server device 120 in response to determining that the target execution result matches none of the at least one predicted execution result, or in response to not receiving the prediction information; receiving a target response for the target execution result from the server device 120; and providing the target response for the target execution result.

In some embodiments, the method 300 further includes: receiving feedback to the provided response; and sending the feedback to the server device 120.

FIG. 4 illustrates a flowchart of a task processing method 400 according to some embodiments of the present disclosure. The method 400 may be implemented at the server device 120. The method 400 will be described below with reference to FIG. 1.

At block 410, the server device 120 determines, in response to receiving a task request from a client device 110, a task execution instruction corresponding to the task request based on the task request.

At block 420, the server device 120 determines prediction information for the task request based on the task execution instruction.

At block 430, the server device 120 sends the prediction information to the client device 110.

In some embodiments, determining the prediction information for the task request based on the task execution instruction includes: determining the prediction information in response to not receiving an execution result of the task execution instruction.

In some embodiments, determining the prediction information for the task request based on the task execution instruction includes: determining the prediction information based on the task execution instruction in response to the task execution instruction being of a predetermined type.

In some embodiments, determining the prediction information for the task request based on the task execution instruction includes: determining at least one predicted execution result corresponding to the task execution instruction based at least on the task execution instruction; determining, with a trained language model, a predicted response respectively corresponding to the at least one predicted execution result; and determining the prediction information based at least on the at least one predicted execution result and the predicted response respectively corresponding to the at least one predicted execution result.

In some embodiments, determining the prediction information based at least on the at least one predicted execution result and the predicted response respectively corresponding to the at least one predicted execution result includes: determining at least one prediction result identification corresponding to the at least one predicted execution result; and determining the prediction information based on the at least one predicted execution result, the at least one prediction result identification, and the predicted response respectively corresponding to the at least one predicted execution result.

In some embodiments, the task request corresponds to a target user, and determining the at least one predicted execution result corresponding to the task execution instruction includes: determining the at least one predicted execution result based on the task execution instruction and historical interaction information associated with the target user.

In some embodiments, sending the prediction information to the client device 110 includes: sending, to the client device 110, a prediction indication for provision of the prediction information in response to determining the prediction information; and sending the prediction information to the client device 110.

In some embodiments, the method 400 further includes: determining a target response for an execution result based on the execution result in response to receiving the execution result from the client device 110; and sending the target response to the client device 110.

In some embodiments, the method 400 further includes: adjusting a determination of the prediction information of a subsequent task request based on feedback to the prediction information in response to receiving the feedback from the client device.

Embodiments of the present disclosure further provide a corresponding apparatus for implementing the above method or process.

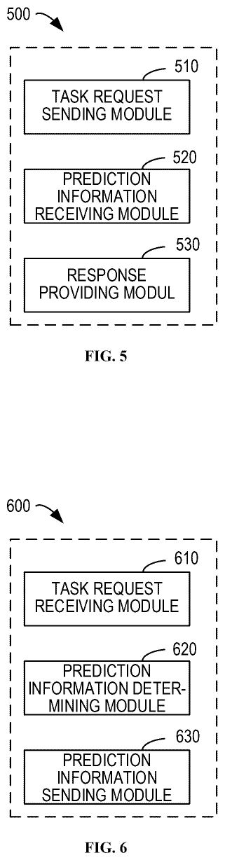

FIG. 5 illustrates an example block diagram of an apparatus 500 for task processing according to some embodiments of the present disclosure. The apparatus 500 may be implemented or included in the client device 110. The various modules/components in the apparatus 500 may be implemented by hardware, software, firmware, or any combination thereof.

As shown in FIG. 5, the apparatus 500 includes a task request sending module 510, a prediction information receiving module 520, and a response providing module 530. The task request sending module 510 is configured to receive, from a server device, a task execution instruction for execution corresponding to a task request in response to sending the task request to the server device. The prediction information receiving module 520 is configured to receive prediction information for the task request from the server device, the prediction information indicating at least one predicted execution result of the task execution instruction and a predicted response respectively corresponding to the at least one predicted execution result. The response providing module 530 is configured to provide, in response to a completion of executing the task execution instruction, a response to the task request based on a match between a target execution result of the task execution instruction and the at least one predicted execution result.

In some embodiments, the prediction information receiving module 520 is further configured to: receive the prediction information from the server device before the completion of executing the task execution instruction; or receive the prediction information from the server device within a preset time period after the completion of executing the task execution instruction.

In some embodiments, the prediction information receiving module 520 is further configured to: receive, from the server device 120, a prediction indication for provision of the prediction information; and receive the prediction information from the server device 120.

In some embodiments, the response providing module 530 is further configured to: compare the target execution result with the at least one predicted execution result; and provide a target predicted response corresponding to a target predicted execution result in response to determining the target predicted execution result that matches the target execution result from the at least one predicted execution result.

In some embodiments, the prediction information further indicates at least one prediction result identification corresponding to the at least one predicted execution result, and the response providing module 530 is further configured to: compare a result identification corresponding to the target execution result with the at least one prediction result identification; and determine that the target predicted execution result corresponding to a target prediction result identification matches the target execution result in response to determining the target prediction result identification that matches the result identification from the at least one prediction result identification.

In some embodiments, the apparatus 500 further includes: an execution result sending module, configured to send the target execution result to the server device 120 in response to determining that the target execution result matches none of the at least one predicted execution result, or in response to not receiving the prediction information; receive a target response for the target execution result from the server device 120; and provide the target response for the target execution result.

In some embodiments, the apparatus 500 further includes: a feedback receiving module, configured to receive feedback to the provided response; and a feedback sending module, configured to send the feedback to the server device 120.

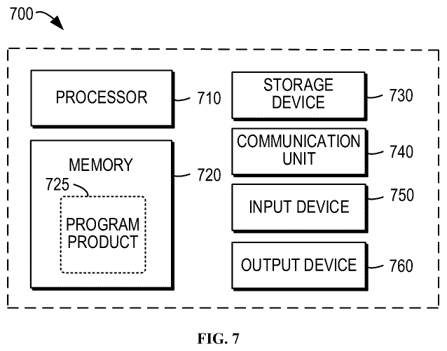

FIG. 6 illustrates an example block diagram of an apparatus 600 for task processing according to some embodiments of the present disclosure. The apparatus 600 may be implemented or included in the server device 120. The various modules/components in the apparatus 600 may be implemented by hardware, software, firmware, or any combination thereof.

As shown in FIG. 6, the apparatus 600 includes a task request receiving module 610, a prediction information determining module 620, and a prediction information sending module 630. The task request receiving module 610 is configured to determine, in response to receiving a task request from a client device, a task execution instruction corresponding to the task request based on the task request. The prediction information determining module 620 is configured to determine prediction information for the task request based on the task execution instruction. The prediction information sending module is configured to send the prediction information to the client device.

In some embodiments, the prediction information determining module 620 is further configured to: determine the prediction information in response to not receiving an execution result of the task execution instruction.

In some embodiments, the prediction information determining module 620 is further configured to: determine the prediction information based on the task execution instruction in response to the task execution instruction being of a predetermined type.

In some embodiments, the prediction information determining module 620 is further configured to: determine at least one predicted execution result corresponding to the task execution instruction based at least on the task execution instruction; determine, with a trained language model, a predicted response respectively corresponding to the at least one predicted execution result; and determine the prediction information based at least on the at least one predicted execution result and the predicted response respectively corresponding to the at least one predicted execution result.

In some embodiments, the prediction information determining module 620 is further configured to: determine at least one prediction result identification corresponding to the at least one predicted execution result; and determine the prediction information based on the at least one predicted execution result, the at least one prediction result identification, and the predicted response respectively corresponding to the at least one predicted execution result.

In some embodiments, the task request corresponds to the target user, and the prediction information determining module 620 is further configured to determine the at least one predicted execution result based on the task execution instruction and historical interaction information associated with the target user.

In some embodiments, the prediction information sending module 630 is further configured to: send a prediction indication for provision of the prediction information to the client device 110 in response to determining the prediction information; and send the prediction information to the client device 110.

In some embodiments, the apparatus 600 further includes: a target response determining module, configured to determine a target response for an execution result based on the execution result in response to receiving the execution result from the client device 110; and a target response sending module, configured to send the target response to the client device 110.

In some embodiments, the apparatus 600 further includes: an adjustment module, configured to adjust a determination of the prediction information of a subsequent task request based on feedback to the prediction information in response to receiving the feedback from the client device.

The modules included in the apparatus 500 and/or the apparatus 600 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of the modules in apparatus 500 and/or apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include, for example, client device 110 and/or server device 120 in FIG. 1.

FIG. 7 illustrates a block diagram of an electronic device 700 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the client device 110 and/or the server device 120 in FIG. 1.

As shown in FIG. 7, the electronic device 700 is in the form of a general-purpose electronic device. Components of the electronic device 700 may include, but are not limited to, one or more processors or processors 710, a memory 720, a storage device 730, one or more communication units 740, one or more input devices 750, and one or more output devices 760. The processor 710 may be an actual or virtual processor and capable of performing various processes according to programs stored in the memory 720. In multiprocessor systems, multiple processors execute computer-executable instructions in parallel to improve parallel processing capabilities of electronic device 700.

Electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some implementations as an update, the functions noted in the blocks may also occur in a different order than that shown in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for task processing, implemented at a client device, comprising:
receiving, from a server device, a task execution instruction for execution corresponding to a task request in response to sending the task request to the server device;
receiving prediction information for the task request from the server device, the prediction information indicating at least one predicted execution result of the task execution instruction and a predicted response respectively corresponding to the at least one predicted execution result; and
providing, in response to a completion of executing the task execution instruction, a response to the task request based on a match between a target execution result of the task execution instruction and the at least one predicted execution result.

2. The method of claim 1, wherein receiving the prediction information for the task request from the server device comprises:
receiving the prediction information from the server device before the completion of executing the task execution instruction; or
receiving the prediction information from the server device within a preset time period after the completion of executing the task execution instruction.

3. The method of claim 1, wherein receiving the prediction information for the task request from the server device comprises:
receiving, from the server device, a prediction indication for provision of the prediction information; and
receiving the prediction information from the server device.

4. The method of claim 1, wherein providing the response to the task request based on a match between the target execution result of the task execution instruction and the at least one predicted execution result comprises:
comparing the target execution result with the at least one predicted execution result; and
providing a target predicted response corresponding to a target predicted execution result in response to determining the target predicted execution result that matches the target execution result from the at least one predicted execution result.

5. The method of claim 4, wherein the prediction information further indicates at least one prediction result identification corresponding to the at least one predicted execution result, and comparing the target execution result with the at least one predicted execution result comprises:
comparing a result identification corresponding to the target execution result with the at least one prediction result identification; and
determining that the target predicted execution result corresponding to a target prediction result identification matches the target execution result in response to determining the target prediction result identification that matches the result identification from the at least one prediction result identification.

6. The method of claim 1, further comprising:
sending the target execution result to the server device in response to determining that the target execution result matches none of the at least one predicted execution result, or in response to not receiving the prediction information;
receiving, from the server device, a target response for the target execution result; and
providing the target response for the target execution result.

7. The method of claim 1, further comprising:
receiving feedback to the provided response; and
sending the feedback to the server device.

8. A method for task processing, implemented at a server device, comprising:
determining, in response to receiving a task request from a client device, a task execution instruction corresponding to the task request based on the task request;
determining prediction information for the task request based on the task execution instruction; and
sending the prediction information to the client device.

9. The method of claim 8, wherein determining the prediction information for the task request based on the task execution instruction comprises:
determining the prediction information in response to not receiving an execution result of the task execution instruction.

10. The method of claim 8, wherein determining the prediction information for the task request based on the task execution instruction comprises:
determining the prediction information based on the task execution instruction in response to the task execution instruction being of a predetermined type.

11. The method of claim 8, wherein determining the prediction information for the task request based on the task execution instruction comprises:
determining at least one predicted execution result corresponding to the task execution instruction based at least on the task execution instruction;
determining, with a trained language model, a predicted response respectively corresponding to the at least one predicted execution result; and
determining the prediction information based at least on the at least one predicted execution result and the predicted response respectively corresponding to the at least one predicted execution result.

12. The method of claim 11, wherein determining the prediction information based at least on the at least one predicted execution result and the predicted response respectively corresponding to the at least one predicted execution result comprises:
determining at least one prediction result identification corresponding to the at least one predicted execution result; and
determining the prediction information based on the at least one predicted execution result, the at least one prediction result identification, and the predicted response respectively corresponding to the at least one predicted execution result.

13. The method of claim 11, wherein the task request corresponds to a target user, and determining the at least one predicted execution result corresponding to the task execution instruction comprises:
determining the at least one predicted execution result based on the task execution instruction and historical interaction information associated with the target user.

14. The method of claim 8, wherein sending the prediction information to the client device comprises:
sending, to the client device, a prediction indication for provision of the prediction information in response to determining the prediction information; and
sending the prediction information to the client device.

15. The method of claim 8, further comprising:
determining a target response for an execution result based on the execution result in response to receiving the execution result from the client device; and
sending the target response to the client device.

16. The method of claim 8, further comprising:
adjusting a determination of the prediction information of a subsequent task request based on feedback to the prediction information in response to receiving the feedback from the client device.

17. An electronic device, comprising:
at least one processor; and
at least one memory coupled to the at least one processor and storing instructions executable by the at least one processor, the instructions, when executed by the at least one processor, causing the electronic device to perform operations comprising:
receiving, from a server device, a task execution instruction for execution corresponding to a task request in response to sending the task request to the server device;
receiving prediction information for the task request from the server device, the prediction information indicating at least one predicted execution result of the task execution instruction and a predicted response respectively corresponding to the at least one predicted execution result; and
providing, in response to a completion of executing the task execution instruction, a response to the task request based on a match between a target execution result of the task execution instruction and the at least one predicted execution result.

18. The electronic device of claim 17, wherein receiving the prediction information for the task request from the server device comprises:
receiving the prediction information from the server device before the completion of executing the task execution instruction; or
receiving the prediction information from the server device within a preset time period after the completion of executing the task execution instruction.

19. The electronic device of claim 17, wherein receiving the prediction information for the task request from the server device comprises:
receiving, from the server device, a prediction indication for provision of the prediction information; and
receiving the prediction information from the server device.

20. The electronic device of claim 17, wherein providing the response to the task request based on a match between the target execution result of the task execution instruction and the at least one predicted execution result comprises:
comparing the target execution result with the at least one predicted execution result; and
providing a target predicted response corresponding to a target predicted execution result in response to determining the target predicted execution result that matches the target execution result from the at least one predicted execution result.
